(19) United States
(12) Patent Application Publication
(10) Pub. No.: US 2026/0111065 A1
(43) Pub. Date: Apr. 23, 2026

(54) ENERGY SCHEDULING FOR INFORMATION HANDLING SYSTEMS

(71) Applicant: Dell Products LP, Round Rock, TX (US)

(72) Inventors: Kearson M. McNulty, Austin, TX (US); Suraj M Varma, Portland, OR (US); Marcus Daniel Molner, Austin, TX (US)

(73) Assignee: Dell Products L.P., Round Rock, TX (US)

(21) Appl. No.: 18/922,812

(22) Filed: Oct. 22, 2024

(51) Int. Cl. G06F 1/28; G06F 1/26

(52) U.S. Cl. CPC G06F 1/28; G06F 1/263

(57) ABSTRACT

Systems and methods are provided for powering an Information Handling System (IHS). Two or more power sources are identified that are available for providing power to the IHS, with the available power sources ranked with a highest ranked (e.g., “greenest”) of the power sources designated as a most preferred power source and the lowest ranked designated as a least preferred power source. A power forecast for the IHS is determined and one or more time windows during the power forecast are identified during which the highest ranked of the plurality of power sources is available. Power draws by the IHS are then scheduled from the highest ranked of the power sources during the identified one or more time windows. Iterate to a next ranked power source, time windows are identified in the remaining power forecast intervals during which the next ranked power source is available.

### FIELD

This disclosure relates generally to Information Handling Systems (IHSs), and more specifically, to managing multiple sources of power available for use by IHSs.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Certain IHSs, such as laptops, tablets and mobile phones, are portable and are designed to operate using DC power supplied by rechargeable batteries. These batteries of portable IHSs are commonly recharged using an AC adapter that is plugged into an external power source. Desktop IHSs and rack-mounted IHSs remain coupled to an external power source. Whether to power ongoing operations and/or to charge batteries, IHSs may draw power from available external power sources. In some locations, these external power sources include green energy sources that rely on renewable energy or other non-fossil fuel sources of energy. In many instances, the green energy sources are available along with conventional energy sources.

### SUMMARY

In various embodiments, systems and methods include an Information Handling System (IHS) comprising: one or more processors; a memory device coupled to the one or more processors, the memory device storing computer-readable instructions that, upon execution by the one or more processors, cause the IHS to: identify a plurality of power sources available for providing power to the IHS, wherein the plurality of available power sources are ranked with a highest ranked of the power sources designated as a most preferred power source and the lowest ranked designated as a least preferred power source; determine a power forecast for the IHS; identify one or more time windows during the power forecast of the IHS during which the highest ranked of the plurality of power sources is available; schedule power draws by the IHS from the highest ranked of the power sources during the identified one or more time windows; and iterate to a next ranked power source to identify one or more time windows remaining the power forecast of the IHS during which the next ranked power source is available.

In some embodiments, the plurality of available power sources are ranked according to their respective environmental impact, with the highest ranked of the power sources having the least environmental impact. In some embodiments, the plurality of available power sources are ranked by a user of the IHS, with the highest ranked of the power sources the most preferred by the user. In some embodiments, the plurality of available power sources are ranked according to an ordering to be used during an outage in one or more of the available power sources, with the lowest ranked of the power sources the last to be utilized during the outage. In some embodiments, the plurality of available power sources comprise a renewable energy power source. In some embodiments, the renewable energy power source comprises a plurality of local renewable energy collectors. In some embodiments, the renewable energy power source comprises a local battery that is charged using the local renewable energy collectors. In some embodiments, the power forecast of the IHS specifies requested power draws for charging one or more batteries of the IHS. In some embodiments, the power forecast of the IHS specifies a request for power draws for immediate charging of the one or more batteries. In some embodiments, the power forecast of the IHS specifies a request for power draws for deferred charging of the one or more batteries. In some embodiments, the identification of a plurality of power sources available for providing power to the IHS comprise power sources that are immediately available for providing power to the IHS and power sources that are forecasted to be available for providing power to the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram depicting certain components of an IHS operable according to various embodiments for scheduling use of green energy in powering the IHS.

FIG. 2 is a swim lane diagram illustrating examples of components of a system configured, according to some embodiments, for scheduling use of green energy in powering an IHS.

FIG. 3 is a flow chart diagram illustrating certain additional steps of a process according to various embodiments for scheduling use of green energy in powering an IHS.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources, such as a Central Processing Unit (CPU) or hardware or software control logic, Read-Only Memory (ROM), and/or other types of nonvolatile memory.

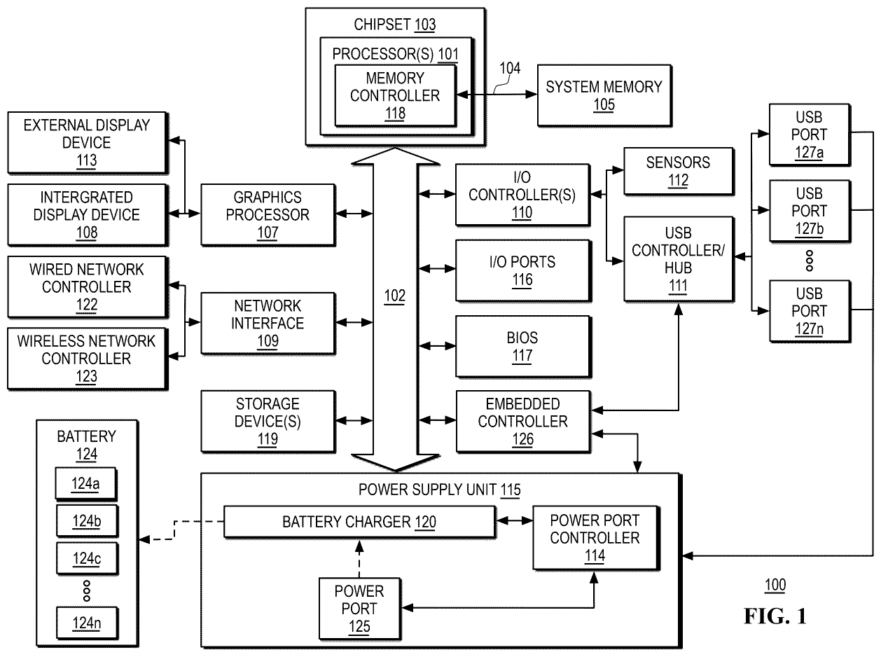

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below. FIG. 1 shows an example of an IHS configured to implement the systems and methods described herein according to certain embodiments. It should be appreciated that although certain IHS embodiments described herein may be discussed in the context of a personal computing device, other embodiments may be utilized.

FIG. 1 is a block diagram depicting certain components of an IHS 100 operable according to various embodiments for scheduling use of green energy in powering the IHS 100, and in particular for charging the batteries of the IHS. As provided above, an IHS may have multiple different power sources available for powering the ongoing operations of the IHS and in charging batteries 124 of the IHS. These power sources may include: one or more conventional electrical supplies provided by area power utilities, power generated locally using a generator, one or more electrical supplies provided by renewable energy providers, locally collected renewable energy, locally stored energy, etc. As described in additional detail below, embodiments provide for scheduling of power draws from the available power sources in a manner that maximizes the use of the most preferred, such as the most environmentally friendly, energy sources, while still accounting for the user's operation of the IHS 100. Through embodiments utilization of the different power sources that are available may be prioritized, while still meeting the expected power demands of the IHS, including periods where the IHS may be expected to operate solely from stored battery power.

IHS 100 includes one or more processors 101, such as a Central Processing Unit (CPU), that execute code retrieved from a system memory 105. Although IHS 100 is illustrated with a single processor 101, other embodiments may include two or more processors, that may each be configured identically, or to provide specialized processing functions. Processor 101 may include any processor capable of executing program instructions, such as an Intel Pentium™ series processor or any general-purpose or embedded processors implementing any of a variety of Instruction Set Architectures (ISAs), such as the x86, POWERPC®, ARM®, SPARC®, or MIPS® ISAs, or any other suitable ISA.

In the embodiment of FIG. 1, the processor 101 includes an integrated memory controller 118 that may be implemented directly within the circuitry of the processor 101, or the memory controller 118 may be a separate integrated circuit that is located on the same die as the processor 101. The memory controller 118 may be configured to manage the transfer of data to and from the system memory 105 of the IHS 100 via a high-speed memory interface 104. The system memory 105 that is coupled to processor 101 provides the processor 101 with a high-speed memory that may be used in the execution of computer program instructions by the processor 101. Accordingly, system memory 105 may include memory components, such as such as static RAM (SRAM), dynamic RAM (DRAM), NAND Flash memory, suitable for supporting high-speed memory operations by the processor 101. In certain embodiments, system memory 105 may combine both persistent, non-volatile memory and volatile memory. In certain embodiments, the system memory 105 may be comprised of multiple removable memory modules.

IHS 100 utilizes a chipset 103 that may include one or more integrated circuits that are connect to processor 101. In the embodiment of FIG. 1, processor 101 is depicted as a component of chipset 103. In other embodiments, all of chipset 103, or portions of chipset 103 may be implemented directly within the integrated circuitry of the processor 101. Chipset 103 provides the processor(s) 101 with access to a variety of resources accessible via bus 102. In IHS 100, bus 102 is illustrated as a single element. Various embodiments may utilize any number of buses to provide the illustrated pathways served by bus 102.

As illustrated, a variety of resources may be coupled to the processor(s) 101 of the IHS 100 through the chipset 103. For instance, chipset 103 may be coupled to a network interface 109 that may support different types of network connectivity. In certain embodiments, IHS 100 may include one or more Network Interface Controllers (NICs), each of which may implement the hardware required for communicating via a specific networking technology, such as Wi-Fi, BLUETOOTH, Ethernet and mobile cellular networks (e.g., CDMA, TDMA, LTE). As illustrated, network interface 109 may support network connections by wired network controllers 122 and wireless network controller 123. Each network controller 122, 123 may be coupled via various buses to the chipset 103 of IHS 100 in supporting different types of network connectivity, such as the network connectivity utilized by applications of the operating system of IHS 100.

Chipset 103 may also provide access to one or more display device(s) 108, 113 via graphics processor 107. In certain embodiments, graphics processor 107 may be comprised within a video or graphics card or within an embedded controller installed within IHS 100. In certain embodiments, graphics processor 107 may be integrated within processor 101, such as a component of a system-on-chip. Graphics processor 107 may generate display information and provide the generated information to one or more display device(s) 108, 113 coupled to the IHS 100. The one or more display devices 108, 113 coupled to IHS 100 may utilize LCD, LED, OLED, or other display technologies. Each display device 108, 113 may be capable of receiving touch inputs such as via a touch controller that may be an embedded component of the display device 108, 113 or graphics processor 107, or may be a separate component of IHS 100 accessed via bus 102. As illustrated, IHS 100 may support an integrated display device 108, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays 113, such as external monitors that may be coupled to IHS 100 via various types of couplings.

In certain embodiments, chipset 103 may utilize one or more I/O controllers 110 that may each support hardware components such as user I/O devices and sensors 112. For instance, I/O controller 110 may provide access to one or more user I/O devices such as a keyboard, mouse, touchpad, touchscreen, microphone, speakers, camera and other input and output devices that may be coupled to IHS 100. Each of the supported user I/O devices may interface with the I/O controller 110 through wired or wireless connections. In certain embodiments, sensors 112 accessed via I/O controllers 110 may provide access to data describing environmental and operating conditions of IHS 100. For instance, sensors 112 may include geo-location sensors capable for providing a geographic location for IHS 100, such as a GPS sensor or other location sensors configured to determine the location of IHS 100 based on triangulation and network information. Various additional sensors, such as optical, infrared and sonar sensors, that may provide support for xR (virtual, augmented, mixed reality) sessions hosted by the IHS 100. Such sensors 112 may capabilities for detecting when a user is detected within a certain proximity to IHS 100. For instance, sensors 112 may detect when a user is in close proximity to the IHS 100 and, in some cases, whether the user is facing the display(s) 108, 113. Sensors 112 may also detect when a user is not in close proximity to the IHS 100, but is nonetheless sufficiently nearby that the user may still be actively using IHS 100, such as by monitoring the progress of an application running on an IHS from across the room.

As illustrated, I/O controllers 110 may include a USB controller 111 that, in some embodiments, may also implement functions of a USB hub. In some embodiments, USB controller 111 may be a dedicated microcontroller that is coupled to the motherboard of IHS 100. In other embodiments, USB controller 111 may be implemented as a function of another component, such as a component of a SoC (System on Chip) of IHS 100, embedded controller 126, processors 101 or of an operating system of IHS 100. USB controller 111 supports communications between IHS 100 and one or more USB devices coupled to IHS 100, whether the USB devices may be coupled to IHS 100 via wired or wireless connections. In some embodiments, a USB controller 111 may operate one or more USB drivers that detect the coupling of USB devices and/or power inputs to USB ports 127a-n. USB controller 111 may include drivers that implement functions for supporting communications between IHS 100 and coupled USB devices, where the USB drivers may support communications according to various USB protocols (e.g., USB 2.0, USB 3.0). In providing functions of a hub, USB controller 111 may support concurrent couplings by multiple USB devices via one or more USB ports 127a-n supported by IHS 100.

In some embodiments, USB controller 111 may control the distribution of both data and power transmitted via USB ports 127a-n. For instance, USB controller 111 may support data communications with USB devices that are coupled to the USB ports 127a-n according to data communication protocols set forth by USB standards. The power transmissions supported by USB controller 111 may include incoming charging inputs received via USB ports 127a-n, as well as outgoing power outputs that are transmitted from IHS 100 to USB devices that are coupled to USB ports 127a-n. In some embodiments, USB controller 111 may interoperate with embedded controller 126 in routing power inputs received via USB ports 127a-n to a battery charger 120 supported by the power supply unit 115 of IHS 100 and in routing power outputs from battery 124 to devices coupled to USB ports 127a-n. In some instances, power outputs provided from battery 124 to devices coupled to USB ports 127a-n may be supported by high-performance battery modes that may be used to rapidly charge the batteries of a device coupled to a USB port 127a-n.

Other components of IHS 100 may include one or more I/O ports 116 that support removeable couplings with various types of peripheral external devices. I/O ports 116 may include various types of ports and couplings that support connections with external devices and systems, either through temporary couplings via ports, such as HDMI ports, accessible to a user via the enclosure of the IHS 100, or through more permanent couplings via expansion slots provided via the motherboard or via an expansion card of IHS 100, such as PCIe slots.

Chipset 103 also provides processor 101 with access to one or more storage devices 119. In various embodiments, storage device 119 may be integral to the IHS 100, or may be external to the IHS 100. In certain embodiments, storage device 119 may be accessed via a storage controller that may be an integrated component of the storage device. Storage device 119 may be implemented using any memory technology allowing IHS 100 to store and retrieve data. For instance, storage device 119 may be a magnetic hard disk storage drive or a solid-state storage drive. In certain embodiments, storage device 119 may be a system of storage devices, such as a cloud drive accessible via network interface 109.

As illustrated, IHS 100 also includes a BIOS (Basic Input/Output System) 117 that may be stored in a non-volatile memory accessible by chipset 103 via bus 102. In some embodiments, BIOS 117 may be implemented using a dedicated microcontroller coupled to the motherboard of IHS 100. In some embodiments, BIOS 117 may be implemented as operations of embedded controller 126. Upon powering or restarting IHS 100, processor(s) 101 may utilize BIOS 117 instructions to initialize and test hardware components coupled to the IHS 100. The BIOS 117 instructions may also load an operating system for use by the IHS 100. The BIOS 117 provides an abstraction layer that allows the operating system to interface with the hardware components of the IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

Some IHS 100 embodiments may utilize an embedded controller 126 that may be a motherboard component of IHS 100 and may include one or more logic units. In certain embodiments, embedded controller 126 may operate from a separate power plane from the main processors 101, and thus from the operating system functions of IHS 100. In some embodiments, firmware instructions utilized by embedded controller 126 may be used to operate a secure execution environment that may include operations for providing various core functions of IHS 100, such as power management and management of certain operating modes of IHS 100.

Embedded controller 126 may also implement operations for interfacing with a power supply unit 115 in managing power for IHS 100. In certain instances, the operations of embedded controller may determine the power status of IHS 100, such as whether IHS 100 is operating strictly from battery power, whether any charging inputs are being received by power supply unit 115, and/or the appropriate mode for charging the one or more battery cells 124a-n using the available charging inputs. Embedded controller 126 may support routing and use of power inputs received via a USB port 127a-n and/or via a power port 125 supported by the power supply unit 115. In addition, operations of embedded controller 126 may interoperate with power supply unit 115 in order to provide battery status information, such as the charge level of the cells 124a-n of battery 124.

In some embodiments, embedded controller 126 may also interface with power supply unit 115 in monitoring the battery state of battery 124, such as the relative state of charge of battery 124, where this charge level of the battery 124 may be specified as a percentage of the full charge capacity of the battery 124. In some instance, when operating from power stored in battery system 124, embedded controller 126 may detect when the voltage of the battery system 124 drops below a low-voltage threshold. When the charge level of battery 124 drops below such a low-voltage threshold, embedded controller 126 may transition the IHS to an off-power state in implementing a battery protection mode that preserves a minimal power level in battery 124.

Embedded controller 126 may also implement operations for detecting certain changes to the physical configuration of IHS 100 and managing the modes corresponding to different physical configurations of IHS 100. For instance, where IHS 100 is a laptop computer or a convertible laptop computer, embedded controller 126 may receive inputs from a lid position sensor that may detect whether the two sides of the laptop have been latched together, such that the IHS is in a closed position. In response to lid position sensor detecting latching of the lid of IHS 100, embedded controller 126 may initiate operations for shutting down IHS 100 or placing IHS 100 in a low-power mode.

In this manner, IHS 100 may support the use of various power modes. In some embodiments, the power modes of IHS 100 may be implemented through operations of the embedded controller 126 and power supply unit 115. In various embodiments, a mobile IHS 100 may support various low power modes in order to reduce power consumption and/or conserve power stored in battery 124. The power modes may include a fully on state in which all, or substantially all, available components of mobile IHS 100 may be fully powered and operational. In a fully off mode, processor(s) 101 may powered off, any integrated storage devices 119 may be powered off, and/or integrated displays 108 may be powered off.

In an intermediate low-power mode, various components of mobile IHS 100 may be powered down, but mobile IHS 100 remains ready for near-immediate use. In a standby power mode, which may be referred to as a sleep state or hibernation state, state information may be stored to storage devices 119 and all but a selected set of components and low-power functions of mobile IHS 100, such as standby functions supported by embedded controller 126, are shut down. In some embodiments, IHS 100 may include various high-power battery modes that may be used to support peak power demands for short durations. Such high-power battery modes allow the IHS to support high-performance computing tasks, but may result in rapid discharge of available battery power.

As described, IHS 100 may also include a power supply unit 115 that receives power inputs used for charging batteries 124 from which the IHS 100 operates. IHS 100 may include a power port 125 to which an AC adapter may be coupled to provide IHS 100 with a supply of DC power. The DC power input received at power port 125 may be utilized by a battery charger 120 for recharging one or more internal batteries 124 of IHS 100. As illustrated, batteries 124 utilized by IHS 100 may include one or more cells 124a-n that may connected in series or in parallel. Power supply unit 115 may support various modes for charging the cells 124a-n of battery 124 based on the power supply available to IHS 100 and based on the charge levels of the battery system 124. In certain embodiments, power supply unit 115 of IHS 100 may include a power port controller 114 that is operable for configuring operations by power port 125. In certain embodiments, power port controller 114 may be an embedded controller that is a motherboard component of IHS 100, a function supported by a power supply unit 115 embedded controller, or a function supported by a system-on-chip implemented by processors 101.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 101 as a systems-on-a-chip.

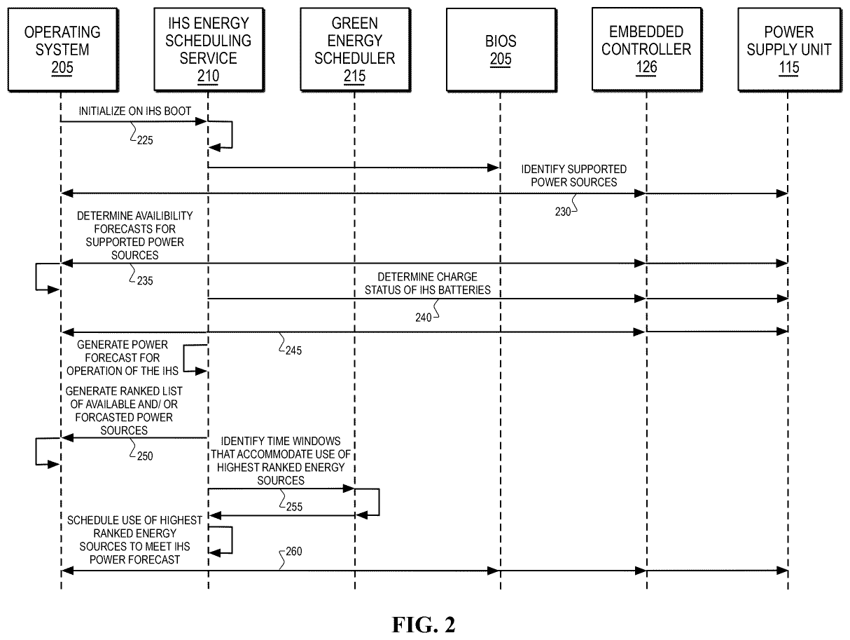

FIG. 2 is a swim lane diagram illustrating examples of components of a system configured, according to some embodiments, for scheduling use of green energy in powering an IHS, and in particular in charging the batteries of an IHS. As described above, multiple different power sources may be available for powering an IHS 100, and thus for charging internal batteries of the IHS. The available power sources may include green energy power sources, such as energy generated from renewable sources. In some locations, electrical utility customers, such as the owner of an IHS 100, may contract for use of conventional energy sources (e.g., coal, natural gas and other fossil fuels) and also for use of renewable energy sources. All power is delivered to the customer via the same transmission lines, but a customer is charged differently based on the energy sources they have contracted to use. In some instances, renewable energy prices may vary throughout the day, such as based on weather conditions and sunlight. Prices for conventional sources of energy may vary, but do so seasonally or in response to specific events, and do not typically fluctuate through the day, or even day to day.

An IHS may also be powered using local renewable energy, such as using power collected by local solar panels, geothermal collectors and windmills. Such locally collected renewable energy is free to the energy customer for use in powering the IHS, without accounting for the costs of the collection system. As local renewable energy capabilities improve, batteries for local storage of collected power are also improving. Accordingly, in some instances, an IHS may be powered from local battery arrays that may be primarily charged using local renewable energy, but may also be charged by other sources. In some instances, an IHS may also be powered using a local generator that may be periodically operated as a source of emergency or supplemental power.

In some instances, the user of the IHS may prefer to use the most environmentally friendly (i.e., greenest) of the sources of power that are available. In embodiments, the sources of available power may be ranked based on the user's preference for use of each energy source, such as ranking the energy sources according to their degree of environmental impact, with conventionally generated fossil-fuel based energy sources on one end of the ranking and locally collected renewable energy on the other end of the ranking. Embodiments may be used in scheduling power draws from the available power sources in a manner that prefers use of the greenest of the available power sources, while accounting for the availability of these power sources and accounting for the expected power needs of the IHS 100.

For an IHS that utilizes rechargeable batteries, selection of a power source results in selection of power for powering operations of the IHS 100 and for recharging of the batteries 124. Through embodiments, recharging of the batteries 124 may be scheduled during intervals when the greenest of the energy sources are forecasted to be available, while still accounting for the user's operation of the IHS 100. For instance, embodiments may generate a power forecast that accounts for intervals of expected use of the IHS with only the use of stored battery power and that specifies other known and expected power needs of the IHS. As described in additional detail below, an IHS may include a green energy scheduler 215 that identifies opportune time windows in the IHS power forecast for use of the greenest energy sources that are currently available, or forecasted to be available within a timely manner.

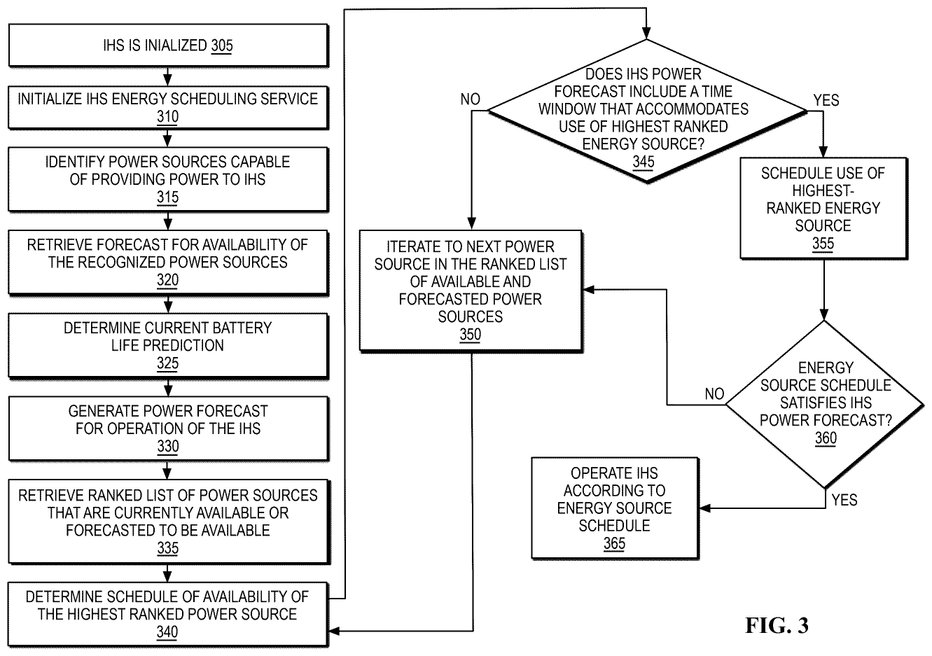

FIG. 3 is a flow chart diagram illustrating certain additional steps of a process according to various embodiments for scheduling use of green energy in powering an IHS, and in particular for charging the batteries 124 of the IHS. As illustrated, embodiments may begin at block 205 with the initialization of an IHS, such as the IHS 100 described with regard to FIG. 1. Once the IHS has been initialized and the operating system of the IHS is booted, the user may commence operation of the IHS and may thus initiate use of software applications that are supported by the operating system of the IHS. The IHS may be operated for any amount of time in the manner, when, at 310, embodiments initiate an energy scheduling service 210.

In some embodiments, the energy scheduling service 210 may run as a process of the operating system 205 of the IHS, and as indicated at 225 of FIG. 2, may be launched by the operating system. In some embodiments, the energy scheduling service 210 may operate as user application of the operating system 205, providing the user with one or more graphical interfaces by which to specify energy use preferences. In some embodiments, some or all of the energy scheduling service 210 may be operated by an embedded controller 126 of the IHS. In such embodiments, the energy scheduling service 210 may be initiated by the embedded controller 126 as a pre-boot process of the secure execution environment operated by the embedded controller. As described with regard to FIG. 1, embedded controller 126 may interface with power supply unit 115 in managing the different supported power modes of an IHS 100 and in managing power draws and charging of batteries 124.

Once the energy scheduling service 210 has been initialized, at 315, each of the different power sources that are supported for providing power to the IHS are identified. As indicated in FIG. 2, in some embodiments, the energy scheduling service 210 may rely on queries to or by the operating system 205, BIOS 220, embedded controller 125 and power supply unity 115 in identifying the power sources that are supported by the IHS 100. As described, such power sources may be conventional AC supply from a utility provider, renewable energy provided by a utility provider and/or various sources of locally collected and stored energy that may be available occasionally or regularly as sources of power to the IHS. As part of this initial evaluation, the energy scheduling service 210 may seek to identify all possible sources of power without regard to their current or forecasted availability.

As indicated in FIG. 3, once the supported sources of power have been identified, at 320, availability forecasts are determined for each of these possible sources of power. In some instances, a source of power may be supported, but is not forecasted to be available in the near future, such as a known unavailability of locally collected solar power due to ongoing cloudy conditions or such as a long-term offline status of a local backup battery that is charged using locally collected renewable energy. As indicated in FIG. 2, the energy scheduling service 210 may rely on the operating system 205 and/or embedded controller 125 in obtaining availability forecasts for each of the supported power sources.

In some embodiments, the operating system 205 may operate one or more power management functions that may maintain a listing of currently available sources of power, where such listing may also provide availability forecasts for each of these currently available power sources. In such embodiments, operating system 205 power management applications may query remote sources of information for power availability, such as to query an API supported by a local power utility to determine the current status, availability and forecasts for availability of conventional and renewable energy delivery. In some embodiments, local power availability may also be managed though user applications of the operating system 205, such that local power availability information may be provided by the operating system.

In some embodiments, some or all of the power availability forecasts may be provided by embedded controller 126. In some embodiments, embedded controller 126 may cooperate with power supply unit 115 in identifying local power sources that are coupled to the IHS 100, such as through a power port 125 coupling of the power supply unit 115. For instance, embedded controller 126 may query the power supply unit 115 for power sources that are currently coupled to the IHS. The embedded controller 126 may utilize network connections 109 supported by the IHS to interface with hardware and/or software used in the management of the local energy sources. For instance, embedded controller 126 may interface via a wireless network connection with a controller of a local solar array in order to determine the current status and any available power forecast that may be provided by the controller of the solar array. In this same manner, embedded controller 126 may interface with controllers managing local power generators, battery arrays, and other renewable energy collectors. As described above, in some embodiments, functions of the operating system 205 may interface with these local sources of energy in determining availability and generating forecasts.

Some embodiments may continue, at 325, with retrieving and/or generating a battery 124 life prediction based on the current state of charge of the battery, and based on the current power state of the IHS. As described above and as indicated in FIG. 2, the embedded controller 126 may interface directly with the power supply unit 115 in generating a battery life prediction that specifies the expected duration of the charge in the batteries 124 based on the current power settings of the IHS 100. This battery life prediction is greatly determined by the current charging status of the IHS, particularly whether the IHS is coupled to an external power source and is thus not draining power from batteries 124, or whether the IHS is operating solely from battery power.

In some instances, the battery life prediction may be zero, or effectively zero when very little charge remains in the IHS batteries 124. In instances where the battery is fully charged and the IHS is already coupled to a power source, the battery life prediction corresponds to the maximum lifespan that the battery 124 is capable of providing. In instances where the IHS is operating from power drawn from batteries 124 and is not coupled to an external source of power, the battery 124 life prediction is a function of the current charge level of the battery and the current power settings of the IHS 100, thus resulting in a remaining lifespan that may typically range from several minutes to tens of hours.

Based on such battery life and power status information, embodiments schedule power draws for ongoing use of the IHS 100, and also for charging of the batteries 124 of the IHS. In order to make such determinations, at 330, the energy scheduling service 210 may generate a power forecast for the IHS 100. In addition to the charge state of the battery 124, a generated power forecast may account for a variety of factors that account for expected operation of the IHS. As such, a generated power forecast may account for the expected intervals of active operation of the IHS, including expected intervals where the IHS will be without external power and will be operating from stored power in batteries 124. As indicated in FIG. 2, the energy scheduling service 210 may generate the IHS power forecast, at 245, through collection of data from the operating system 205 and embedded controller 126.

For instance, the energy scheduling service 210 may interface with the operating system 205 in order to access the upcoming schedule of the user of the IHS, where this schedule may include meetings or other events during which it may be expected that IHS may be operated without a source of external power. The operating system 205 may also maintain and provide a profile of the user's normal hours of operation of the IHS, such as the times each day at which the user typically commences and ends use of the IHS, as well the intervals during each day when heavy use of the IHS is typical. The energy scheduling service 210 may incorporate various such user information into the IHS power forecast that is generated.

The energy scheduling service 210 may also incorporate various characteristics of the current operating state of the IHS 100 into the IHS power forecast. For instance, embodiments may generate a power forecast that requests access to maximum power draw of the IHS in a variety of operating conditions. For example, indications that the IHS is in an error state, or that critical functions of the IHS relied on by embodiments in scheduling power draws, may result in a maximum power forecast that does not defer any power draws. As described in additional detail below, embodiments may schedule power draws providing maximum power, but may still prefer use of the greenest energy source that is currently available to the IHS 100. Embodiments may similarly generate a maximum power forecast in response to operating system 205 information indicating that the IHS 100 requires a restart and/or updates.

The energy scheduling service 210 may also generate the IHS power forecast based on information provided by the embedded controller 126, such as information relating to current battery state and charging capabilities reported by the power supply unit 115. For instance, a maximum power forecast may also result in scenarios where IHS batteries 124 are depleted, or mostly depleted, such as below a twenty percent threshold, where such battery information is reported by the embedded controller 126. In such circumstances, no power draws are deferred and power may be drawn from any source that is available, while still preferring use of the greenest energy source that is currently available.

In some embodiments, the battery condition and charging information provided by the embedded controller 126 may be incorporated into the IHS power forecast generated by the energy scheduling service 210. For instance, in a scenario where the embedded controller 126 reports that battery 124 is not fully charged and also reports a deteriorated state of battery 124 such that the maximum life of the battery is below a certain threshold, maximum power draws may be specified in the IHS power forecast in order to maintain the battery 124 in a fully charged state until it can be replaced. Similarly, a report from the embedded controller 126 indicating that charging times for the batteries 124 are longer that a certain threshold due to deterioration in the AC adapter may also result in a maximum power forecast that seeks to maintain the battery 124 in a fully charged state.

In scenarios where the batteries 124 are fully charged, the generated power forecast may omit power draws for battery charging. However, in some scenarios, expected use of the IHS 100 may result in a power forecast that includes future power draws for charging batteries 124, such as after participating in a regularly scheduled event where the IHS is operated from stored battery 124 power and without an external source of power. Such future power draws for battery charging may be included in the power forecast in order to account for expected travel or other use of the IHS while the user is mobile, or at least operating the IHS at remote locations at which the IHS is not regularly used.

In scenarios where the battery 124 is currently less than full charge and/or when charging of the battery is anticipated, embodiments may select from the available power sources in order to draw power for charging of the battery 124. In order to make this determination regarding sources for power draws, at 335, embodiments retrieve a ranked list of the power sources that are currently available and/or that are forecasted to be available during the duration of the generated IHS power forecast. As described above, at 235, the energy scheduling service 210 may compile a forecast of all available and forecasted to be available sources of power supported by the IHS. As indicated in FIG. 2, at 250, the energy scheduling service 210 may interface with the operating system 205 to determine a ranked list of these available energy sources, where the available energy sources that are ranked may be culled to include only those that include forecasted availability during the duration of the IHS power forecast.

As described above, the energy sources that are available may be ranked according to their relative environmental impact, with the highest ranked of the energy sources being the most environmentally friendly (i.e., most “green”) and the lowest ranked being the least environmentally friendly. In embodiments, such energy source rankings may be maintained and distributed in a variety of manners and by a variety of sources. In some embodiments, energy source rankings may be generated through the compilations of other rankings. In some embodiments, some or all of the rankings used by the energy scheduling service 210 may be retrieved and/or maintained by the operating system 205. The energy scheduling service 210 may utilize retrieved information in ranking the energy sources as well as user inputs related to the preferred use of different energy sources that are supported by the IHS 100.

In some embodiments, user inputs may specify preferences for the use of locally collected and/or stored energy. For instance, initial configuration of the energy scheduling service 210 may include the collection of user inputs that rank or otherwise specify preferences for each of the available sources, such as specifying a highest ranking for use of locally collected energy. In a scenario where a local generator is a supported power source, user preferences may indicate this is the lowest ranked of the energy sources, and thus usable only in emergencies when no other power source is available. However, in a scenario where a user faces peak-demand pricing for conventional energy provided by a local utility, a user may indicate a preference for use of a local generator over conventional energy during such conditions. In this same manner, a user with a local battery array that is charged using locally collected renewable energy, such as an array of solar panels or windmills, may indicate a preference for use of stored battery charging whenever it is available, thus making this the highest ranked of the energy sources. In a scenario where a user anticipates a need for use of the local battery due to outages, user preferences may set the local battery as the lowest ranked of the energy sources, and thus used only when none of the other energy sources are available.

In this manner, a user may similarly specify preferences for use of renewable energy, whether collected locally or collected elsewhere and received via the local electrical grid. For instance, a user may rank all renewable energy sources above conventional energy sources without qualifications, thus expressing a preference for green energy whenever it is available. In some embodiments, a user may specify conditions during when green energy is preferred and thus higher ranked than conventional energy sources, such as during portions of the day during which conventional energy may be subject to peak demand pricing. A user may similarly specify a preference for locally collected renewable energy whenever it is available.

Once the ranked list of available energy sources has been generated, at 255, the energy scheduling service 210 identifies one or more time windows during the IHS power forecast, where each time window specifies an interval for drawing power from one of power sources that is currently available and/or forecasted to be available during the duration of the IHS power forecast, where the energy source that is selected for each time window is the highest ranked of the energy sources that is available during that time interval. As indicated in FIG. 2, the energy scheduling service 210 may rely on a green energy scheduler 215 in identifying these time windows of the greenest energy source that is available in meeting the power demands in each portion of the IHS power forecast, in particular power demands for charging of the batteries 124 of the IHS.

As indicated in FIG. 3, the green energy scheduler 215 may begin this analysis of the IHS power forecast to identify the greenest time windows of energy consumption, at 340, by identifying the highest ranked of the available and/or forecasted power sources. At 345, the green energy scheduler 215 proceeds to identify any time windows during the IHS power forecast during which the greenest energy source is available. The green energy scheduler 215 may begin by looking for the longest time window in the IHS power forecast that coincides with an interval of availability of the highest ranked energy source. The green energy scheduler 215 may search for progressively shorter windows in the IHS power forecast until there is a window that coincides with an interval of availability of the highest ranked energy source. In this manner, one or more windows of power draws from the greenest of the available energy sources may be identified.

Once any available time windows have been identified for the greenest of the available energy sources, at 350, power draws from this energy source are scheduled during these intervals by the energy scheduling service 210. As indicated at 260 of FIG. 2, the energy scheduling service 210 may interface with the operating system 205, BIOS 220, and embedded controller 126 in scheduling power draws from a specific energy source. Once this power draw has been scheduled, at 360, the energy scheduling service 210 determines whether the IHS power forecast has been satisfied.

In some scenarios, the full IHS power forecast may be satisfied using the highest ranked energy source. For instance, the IHS power forecast for the next ten hours may be satisfied using only power from a renewable energy source that is provided by a public utility, which may be the highest ranked energy source. Similarly, a six hour IHS power forecast may be satisfied using only locally collected renewable energy during a period when this highest ranked energy source is available and sufficient to satisfy the full power draw required by the IHS for the duration of the power forecast. In scenarios where the highest ranked energy source is available and able to satisfy the full IHS power forecast, at 365, the operates using the scheduled power draws. The IHS may operate in this manner for the duration of the IHS power forecast, or may repeat the scheduling of power draws based on an update to the IHS power forecast, such as due to the IHS being unplugged from a power source or such as the coupling of external devices to the IHS that will draw power from the IHS.

In many scenarios, the highest ranked energy source may not be sufficient to satisfy the full IHS power forecast. For instance, the highest ranked energy source may be locally collected renewable energy, but the availability of this energy source may be insufficient to meet the full needs of the IHS power forecast. Accordingly, time windows in the IHS power forecast are identified by the green energy scheduler 215 where power can be drawn from available collected renewable energy. In scenarios where the highest ranked energy source does not provide sufficient power to satisfy the IHS power forecast, at 350, the energy scheduling service 210 iterates to the next energy source in the ranked list of energy sources that have been determined to be available or forecasted to be available during the IHS power forecast.

After iterating to the next energy source in the ranked list, embodiments return, at 340, with the green energy scheduler 215 identifying the availability schedule for the next highest rated energy source. As above, the green energy scheduler 215 identifies any time intervals where the availability of this energy source can be used to satisfy the IHS power forecast, or the remaining parts of the IHS power forecast that have not already been addressed with power draws from the higher ranked energy source. If any intervals can be identified by the green energy scheduler 215, power draws from this power source are scheduled for these intervals and the green energy scheduler 215 continues iterating through the ranked list.

Iterations continue until the IHS power forecast has been met, or the available energy sources have been exhausted. In this manner, embodiments provide scheduled use of the greenest energy sources that are presently available to an IHS, and that are forecasted to be available in a timely manner. Embodiments also support prioritized use of available power sources during outages and expected outages. When attempting to prolong IHS battery life for as long as possible, such as during an outage or an expected outage in public utility supply of conventional and renewable energy, embodiments may iterate through available power sources based on their relative rankings. In one possible ranking, embodiments thus use public utility services as much as possible while they available and fail over to local generators, local renewable energy collectors and battery arrays, in that ranked order. Through embodiments, power for charging IHS batteries may be conducted during outage scenarios according to these failover procedures, such as a ranking that results in reliance on renewable energy and generators for as long as possible, before resorting to use of the battery array. Based on embodiments, users may customize emergency power draws according to their power needs and the availability and sustainability of each of the available power sources.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
one or more processors;
a memory device coupled to the one or more processors, the memory device storing computer-readable instructions that, upon execution by the one or more processors, cause the IHS to:
identify two or more power sources available for providing power to the IHS, wherein the available power sources are ranked with a highest ranked of the power sources designated as a most preferred power source and the lowest ranked designated as a least preferred power source;
determine a power forecast for the IHS;
identify one or more time windows during the power forecast of the IHS during which the highest ranked of the plurality of power sources is available;
schedule power draws by the IHS from the highest ranked of the power sources during the identified one or more time windows; and
iterate to a next ranked power source to identify one or more time windows remaining the power forecast of the IHS during which the next ranked power source is available.

2. The IHS of claim 1, wherein the available power sources are ranked according to their respective environmental impact, with the highest ranked of the power sources having the least environmental impact.

3. The IHS of claim 1, wherein the available power sources are ranked by a user of the IHS, with the highest ranked of the power sources the most preferred by the user.

4. The IHS of claim 1, wherein the power sources are ranked according to an ordering to be used during an outage in one or more of the available power sources, with the lowest ranked of the power sources the last to be utilized during the outage.

5. The IHS of claim 1, wherein the power sources comprise a renewable energy power source.

6. The IHS of claim 5, wherein the renewable energy power source comprises a plurality of local renewable energy collectors.

7. The IHS of claim 6, wherein the renewable energy power source comprises a local battery that is charged using the local renewable energy collectors.

8. The IHS of claim 1, wherein the power forecast of the IHS specifies requested power draws for charging one or more batteries of the IHS.

9. The IHS of claim 8, wherein the power forecast of the IHS specifies a request for power draws for immediate charging of the one or more batteries.

10. The IHS of claim 8, wherein the power forecast of the IHS specifies a request for power draws for deferred charging of the one or more batteries.

11. The IHS of claim 1, wherein the two or more power sources available for providing power to the IHS comprise power sources that are immediately available for providing power to the IHS and power sources that are forecasted to be available for providing power to the IHS.

12. A method for powering an Information Handling System (IHS) comprising one or more rechargeable batteries, the method comprising:
identifying two or more plurality of power sources available for providing power to the IHS, wherein the available power sources are ranked with a highest ranked of the power sources designated as a most preferred power source and the lowest ranked designated as a least preferred power source;
determining a power forecast for the IHS;
identifying one or more time windows during the power forecast of the IHS during which the highest ranked of the plurality of power sources is available;
scheduling power draws by the IHS from the highest ranked of the power sources during the identified one or more time windows; and
iterating to a next ranked power source to identify one or more time windows remaining the power forecast of the IHS during which the next ranked power source is available.

13. The method of claim 12, wherein the available power sources are ranked according to their respective environmental impact, with the highest ranked of the power sources having the least environmental impact.

14. The method of claim 12, wherein the available power sources comprise a renewable energy power source.

15. The method of claim 12, wherein the power forecast of the IHS specifies requested power draws for charging the one or more batteries of the IHS.

16. The method of claim 12, wherein the two or more power sources available for providing power to the IHS comprise power sources that are immediately available for providing power to the IHS and power sources that are forecasted to be available for providing power to the IHS.

17. A computer-readable storage device having instructions stored thereon for powering an Information Handling System (IHS) comprising one or more rechargeable batteries, wherein execution of the instructions by one or more processors of the IHS causes the one or more processors to:
identify two or more power sources available for providing power to the IHS, wherein the available power sources are ranked with a highest ranked of the power sources designated as a most preferred power source and the lowest ranked designated as a least preferred power source;
determine a power forecast for the IHS;
identify one or more time windows during the power forecast of the IHS during which the highest ranked of the plurality of power sources is available;
schedule power draws by the IHS from the highest ranked of the power sources during the identified one or more time windows; and
iterate to a next ranked power source to identify one or more time windows remaining the power forecast of the IHS during which the next ranked power source is available.

18. The computer-readable storage device of claim 17, wherein the available power sources are ranked according to their respective environmental impact, with the highest ranked of the power sources having the least environmental impact.

19. The computer-readable storage device of claim 17, wherein the power forecast of the IHS specifies requested power draws for charging the one or more batteries of the IHS.

20. The computer-readable storage device of claim 17, wherein the two or more power sources available for providing power to the IHS comprise power sources that are immediately available for providing power to the IHS and power sources that are forecasted to be available for providing power to the IHS.
